(19) United States
(12) Patent Application Publication
(10) Pub. No.: US 2023/0408143 A1
(43) Pub. Date: Dec. 21, 2023

(54) SILENCING STRUCTURE AND SILENCING SYSTEM

(71) Applicant: FUJIFILM Corporation, Tokyo (JP)

(72) Inventors: Yoshihiro SUGAWARA, Ashigarakami-gun (JP); Shogo Yamazoe, Ashigarakami-gun (JP); Yuichiro Itai, Ashigarakami-gun (JP)

(73) Assignee: FUJIFILM Corporation, Tokyo (JP)

(21) Appl. No.: 18/363,812

(22) Filed: Aug. 2, 2023

Related U.S. Application Data
(63) Continuation of application No. PCT/JP22/00504, filed on Jan. 11, 2022.

(30) Foreign Application Priority Data
Feb. 3, 2021 (JP) 2021-015749

(51) Int. Cl. F24F 13/24

(52) U.S. Cl. CPC F24F 13/24; F24F 2013/242

(57) ABSTRACT

To provide a silencing structure and a silencing system having a high sound absorbance in a low frequency region. A silencing structure that is installed in a tubular member, the silencing structure includes a cavity portion, an opening portion through which the cavity portion communicates with the tubular member, and a closing portion that closes the cavity portion at a position facing the opening portion, in which a cross-sectional area of the cavity portion on a side of the opening portion is larger than a cross-sectional area of the cavity portion on a side of the closing portion.

### CROSS-REFERENCE TO RELATED APPLICATIONS

This application is a Continuation of PCT International Application No. PCT/JP2022/000504 filed on Jan. 11, 2022, which claims priority under 35 U.S.C. § 119(a) to Japanese Patent Application No. 2021-015749 filed on Feb. 3, 2021. The above applications are hereby expressly incorporated by reference, in their entirety, into the present application.

### BACKGROUND OF THE INVENTION

### 1. Field of the Invention

The present invention relates to a silencing structure and a silencing system.

### 2. Description of the Related Art

In a tubular member (ventilation sleeve) that penetrates between indoor and outdoor areas, such as a ventilation port and an air conditioning duct, which is provided on a wall that separates the indoor and outdoor areas, in order to suppress transmission of a noise from the outdoor area to the indoor area, or in order to suppress transmission of a noise from the indoor area to the outdoor area, a porous sound absorbing material made of urethane, polyethylene, or the like is installed in the ventilation sleeve.

However, in a case in which the porous sound absorbing material made of urethane, polyethylene, or the like is used, an absorbance of a sound having a low frequency of 1000 Hz or less is extremely lowered. Therefore, in order to increase the absorbance, it is required to increase the volume. However, since it is required to ensure the ventilation property of the ventilation port, the air conditioning duct, or the like, a size of the porous sound absorbing material is limited, and there is a problem that it is difficult to achieve both high ventilation property and soundproof performance.

In order to make soundproof of a noise having a low frequency of 1000 Hz or less using the porous sound absorbing material, an amount of the porous sound absorbing material is remarkably increased. Therefore, it is generally difficult to obtain sufficient soundproof performance even at the expense of ventilation.

In addition, as a silencer, a resonance type silencer that silences a sound in the vicinity of a resonance frequency of the silencer is also proposed. However, in a case of the resonance type silencer, a length of at least ¼ of a wavelength of the resonance frequency is required, and the size of the silencer is increased. Therefore, there is a problem that it is difficult to achieve both high ventilation property and soundproof performance. Also, the resonance type silencer silences a sound having a specific frequency. Therefore, the resonance sound to be silenced is limited to only one frequency, and a frequency band to be silenced by the resonance type silencer is narrow. Therefore, there is a problem that resonance sounds of other frequencies cannot be silenced.

On the other hand, as a small-sized silencer capable of silencing in a wide band including a low frequency, a silencer that includes a cavity portion and an opening portion through which the cavity portion communicates with the ventilation sleeve, and silences the sound without using the resonance is proposed.

For example, JP2019-133122A discloses a silencing system in which a silencing device that silences a sound passing through a ventilation sleeve is installed in the ventilation sleeve installed to penetrate through a wall, in which the silencing device silences a sound having a frequency including a frequency of first resonance generated in the ventilation sleeve, the silencing device comprises one or more silencer that have a cavity portion and an opening portion through which the cavity portion communicates with an outside, and that are disposed one end surface side of the wall, and a sound absorbing material that is disposed in at least a part of the cavity portion of the silencer or at a position that covers at least a part of the opening portion of the silencer, the opening portion of the silencer is disposed to face a central axis side of the ventilation sleeve, in a case in which an area of the opening portion of the silencer is denoted by S₁ and a surface area of an interior wall of the cavity portion is denoted by S_{d}, a ratio S₁/S_{d} of the area S₁ to the area S_{d} satisfies 0%<S₁/S_{d}<40%, in a case in which a wavelength of a sound wave at a resonance frequency of the first resonance of the ventilation sleeve in the silencing system including the silencing device is denoted by λ, a depth L_{d} of the cavity portion satisfies 0.011×λ<L_{d}<0.25×λ, and the silencer does not resonate with the sound having the frequency of the first resonance generated in the ventilation sleeve, and does not silence the sound having the frequency of the first resonance by the resonance of the silencer itself, but silences the sound by the sound absorbing material.

### SUMMARY OF THE INVENTION

In the silencer that includes the cavity portion and the opening portion through which the cavity portion communicates with the ventilation sleeve and silences the sound without using the resonance, it is required to further increase a low frequency sound absorbance.

The present invention is to solve the above-described problems of the related art and to provide a silencing structure and a silencing system having a high sound absorbance in a low frequency region.

In order to solve this problems, the present invention has the configurations as follows.

[1] A silencing structure that is installed in a tubular member, the silencing structure comprising a cavity portion, an opening portion through which the cavity portion communicates with the tubular member, and a closing portion that closes the cavity portion at a position facing the opening portion, in which a cross-sectional area of the cavity portion on a side of the opening portion is larger than a cross-sectional area of the cavity portion on a side of the closing portion.

[2] The silencing structure according to [1], in which at least one angle formed by line segments that are in contact with a vertex of the cavity portion that is not in contact with the opening portion is larger than π/2 [rad].

[3] The silencing structure according to [1] or [2], in which, in a cross section perpendicular to an axial direction of the tubular member, a width of the cavity portion is narrowed as a distance from the opening portion is increased.

[4] The silencing structure according to any one of [1] to [3], in which the silencing structure has a rib structure.

[5] The silencing structure according to any one of [1] to [4], in which a density of members constituting the silencing structure is 0.5 g/cm³ to 2.5 g/cm³.

[6] The silencing structure according to any one of [1] to [5], in which a porous sound absorbing material is provided in the cavity portion.

[7] A silencing system in which the silencing structure according to any one of [1] to [6] is installed in the tubular member, the silencing system comprising two or more silencing structures consisting of components having the same shape.

[8] A silencing system in which the silencing structure according to any one of [1] to [6] is installed in the tubular member, the silencing system comprising two or more silencing structures, in which at least two silencing structures are formed by one mold.

[9] A silencing system in which the silencing structure according to any one of [1] to [6] is installed in the tubular member, in which the silencing structure does not occupy 50% or more of a cross-sectional area perpendicular to an axial direction of the tubular member.

According to the present invention, it is possible to provide the silencing structure and the silencing system having the high sound absorbance in the low frequency region.

### BRIEF DESCRIPTION OF THE DRAWINGS

FIG. 1 is a cross-sectional view conceptually showing an example of a silencing system having a silencing structure according to an embodiment of the present invention.

FIG. 2 is a cross-sectional view taken along a line b-b of FIG. 1.

FIG. 3 is a perspective view of the silencing structure shown in FIG. 1.

FIG. 4 is a perspective view showing another example of the silencing structure according to the embodiment of the present invention.

FIG. 5 is a cross-sectional view conceptually showing a silencing system having another example of the silencing structure according to the embodiment of the present invention.

FIG. 6 is a cross-sectional view taken along line c-c of FIG. 5.

FIG. 7 is a conceptual diagram for describing a shape of another example of the silencing structure.

FIG. 8 is a conceptual diagram for describing the shape of another example of the silencing structure.

FIG. 9 is a conceptual diagram for describing the shape of another example of the silencing structure.

FIG. 10 is a conceptual diagram for describing the shape of another example of the silencing structure.

FIG. 11 is a conceptual diagram for describing the shape of another example of the silencing structure.

FIG. 12 is a conceptual diagram for describing the shape of another example of the silencing structure.

FIG. 13 is a conceptual diagram for describing the shape of another example of the silencing structure.

FIG. 14 is a diagram for describing a structure of a silencer in the related art.

FIG. 15 is a diagram for describing a structure of the silencing structure according to the embodiment of the present invention.

FIG. 16 is a diagram for describing a problem of a silencing structure in the related art.

FIG. 17 is a diagram for describing another action of the silencing structure according to the embodiment of the present invention.

FIG. 18 is a conceptual diagram for describing an action in a case of manufacturing the silencing structure.

FIG. 19 is a diagram for describing a problem of the silencing structure in the related art.

FIG. 20 is a diagram for describing another action of the silencing structure according to the embodiment of the present invention.

FIG. 21 is a conceptual diagram showing an example of another configuration of the silencing structure according to the embodiment of the present invention.

FIG. 22 is an exploded view of the silencing structure shown in FIG. 21.

FIG. 23 is a conceptual diagram showing a state of a component constituting the silencing structure shown in FIG. 21 during transportation.

FIG. 24 is a perspective view conceptually showing another example of the silencing structure according to the embodiment of the present invention.

FIG. 25 is a diagram showing a plate member that has no rib structure.

FIG. 26 is a conceptual diagram of a graph of a sound pressure and a sound insulation characteristic for describing a resonance frequency due to the plate member shown in FIG. 25.

FIG. 27 is a diagram showing a plate member having the rib structure.

FIG. 28 is a conceptual diagram of a graph of the sound pressure and the sound insulation characteristic for describing the resonance frequency due to the plate member shown in FIG. 27.

FIG. 29 is a diagram for describing a method of measuring a transmission loss due to the plate member.

FIG. 30 is a graph showing a relationship between a frequency and the transmission loss.

FIG. 31 is a diagram conceptually showing another example of the rib structure included in the silencing structure according to the embodiment of the present invention.

FIG. 32 is a diagram conceptually showing another example of the rib structure included in the silencing structure according to the embodiment of the present invention.

FIG. 33 is a diagram conceptually showing another example of the rib structure included in the silencing structure according to the embodiment of the present invention.

FIG. 34 is a diagram conceptually showing another example of the rib structure included in the silencing structure according to the embodiment of the present invention.

FIG. 35 is a diagram conceptually showing another example of the rib structure included in the silencing structure according to the embodiment of the present invention.

FIG. 36 is a diagram conceptually showing another example of the rib structure included in the silencing structure according to the embodiment of the present invention.

FIG. 37 is a diagram for describing a calculation model of a silencing system according to Examples.

FIG. 38 is a graph showing a relationship between the frequency and the transmission loss.

FIG. 39 is a graph showing the frequency and a change in the transmission loss.

FIG. 40 is a graph showing a relationship between the frequency and the transmission loss.

FIG. 41 is a graph showing the frequency and the change in the transmission loss.

FIG. 42 is a graph showing a relationship between the frequency and the transmission loss.

FIG. 43 is a graph showing the frequency and the change in the transmission loss.

FIG. 44 is a graph showing a relationship between the frequency and the transmission loss.

FIG. 45 is a graph showing the frequency and the change in the transmission loss.

FIG. 46 is a graph showing a relationship between the frequency and the transmission loss.

FIG. 47 is a graph showing the frequency and the change in the transmission loss.

### DESCRIPTION OF THE PREFERRED EMBODIMENTS

The present invention will be described below in detail.

The configuration requirements shown below are described based on a representative embodiment of the present invention, but the present invention is not limited to such an embodiment.

It should be noted that, in the present specification, a numerical range represented by “to” means a range including numerical values described before and after “to” as a lower limit value and an upper limit value.

Also, in the present specification, “orthogonal” and “parallel” include a range of errors allowed in the technical field to which the present invention belongs. For example, “orthogonal” and “parallel” mean that the it is within a range of less than ±10° with respect to strict orthogonality or parallelism, and the error with respect to strict orthogonality or parallelism is preferably 5° or less, and more preferably 3° or less.

In the present specification, “the same” includes an error range generally allowed in the technical field.

[Silencing Structure]

A silencing structure according to an embodiment of the present invention is a silencing structure that is installed in a tubular member, the silencing structure including a cavity portion, an opening portion through which the cavity portion communicates with the tubular member, and a closing portion that closes the cavity portion at a position facing the opening portion, in which a cross-sectional area of the cavity portion on an opening portion side is larger than a cross-sectional area of the cavity portion on a closing portion side.

[Silencing System]

A silencing system according to the embodiment of the present invention is a silencing system in which the silencing structure is installed on the tubular member.

In the silencing system according to the embodiment of the present invention, it is preferable that the installed silencing structure does not occupy 50% or more of a cross-sectional area perpendicular to an axial direction of the tubular member.

The configurations of the silencing structure and the silencing system according to the embodiment of the present invention will be described with reference to the drawings.

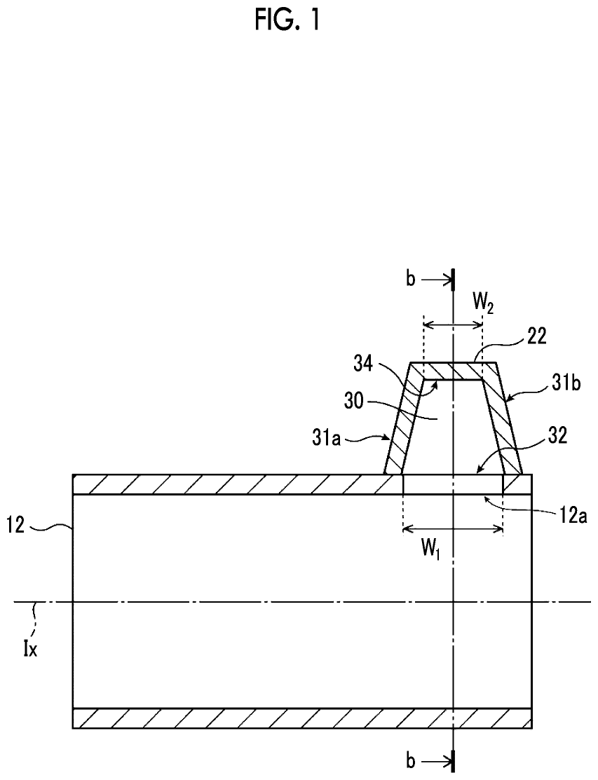

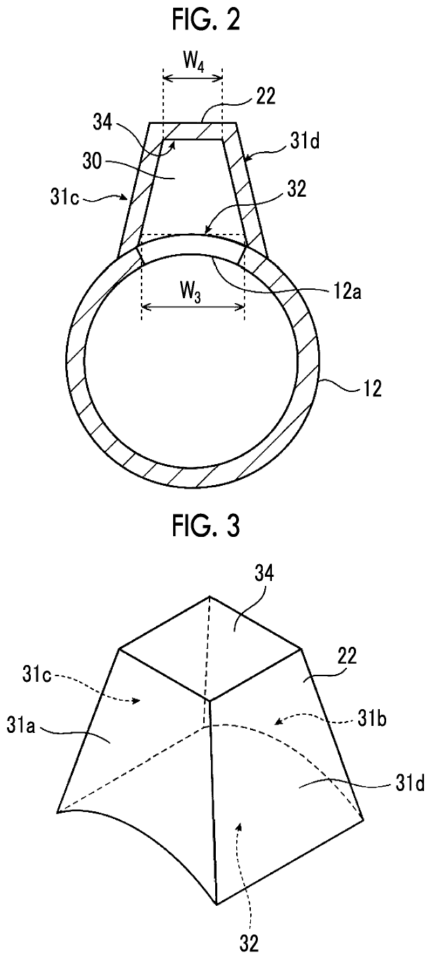

FIG. 1 is a schematic cross-sectional view showing an example of an embodiment of the silencing system having the silencing structure according to the embodiment of the present invention. FIG. 2 is a cross-sectional view taken along a line b-b of FIG. 1. FIG. 3 is a perspective view of the silencing structure of FIG. 1. Specifically, FIG. 1 shows a cross section that is parallel to an axial direction of a central axis Ix of a tubular member 12 and passes through the center of a connection hole 12a (opening portion 32). Hereinafter, this cross section will also be referred to as a “transverse cross section”. In addition, FIG. 2 shows a cross section perpendicular to the axial direction of the central axis Ix of the tubular member 12. Hereinafter, this cross section will also be referred to as a “front cross section”. In addition, the axial direction of the central axis Ix of the tubular member 12 is also simply referred to as “axial direction”.

As shown in FIGS. 1 and 2, the silencing system 10 includes the cylindrical tubular member 12 and a silencing structure 22 disposed on an outer peripheral portion of the tubular member 12. The silencing structure 22 includes a cavity portion 30, the opening portion 32, and a closing portion 34, and may silence a sound by generating Helmholtz resonance or air column resonance, or may silence the sound by converting sound energy into thermal energy without the resonance.

The tubular member 12 is, for example, a ventilation sleeve, such as a ventilation port and an air conditioning duct.

It should be noted that the tubular member 12 is not limited to the ventilation port, the air conditioning duct, and the like, and may be a general duct used in various devices.

Among these, a wall of a house, such as an apartment, includes, for example, a concrete wall, a gypsum board, a heat insulating material, a decorative plate, and a wallpaper, and the ventilation sleeve is provided through the concrete wall, the gypsum board, the heat insulating material, the decorative plate, and the wallpaper. The silencing structure according to the embodiment of the present invention can be suitably applied to such a ventilation sleeve of the wall.

It should be noted that a cross-sectional shape of the ventilation sleeve is not limited to a circular shape, and may be various shapes, such as a quadrangular shape and a triangular shape. In addition, the cross-sectional shape of the ventilation sleeve does not have to be constant in the axial direction of the central axis of the ventilation sleeve. In other words, a diameter of the ventilation sleeve may be changed in the axial direction.

In addition, in a case of a ventilation sleeve for a residential use, the diameter (circle-equivalent diameter) of the ventilation sleeve is about 70 mm to 160 mm. In a case in which the diameter of the ventilation sleeve is changed in the axial direction, an average inner diameter (weighted average) of the ventilation sleeve need only be about 70 mm to 160 mm.

It should be noted that an inner diameter of the ventilation sleeve is measured with a resolution of 1 mm. In a case in which the cross-sectional shape of the ventilation sleeve is not circular, the inner diameter is obtained by converting an area as a circle-equivalent area into a diameter. In a case of having a fine structure, such as unevenness of less than 1 mm, the unevenness is averaged.

As shown in FIGS. 1 and 2, the connection hole 12a that penetrates from the inside to the outside of the tubular member 12 is formed in a part of an outer peripheral surface of the tubular member 12. In the shown example, a size of the connection hole 12a is substantially the same as a size of the opening portion 32 of the silencing structure 22 described below.

As shown in FIG. 3, the silencing structure 22 has an outer shape which is a substantially square frustum shape, includes the cavity portion 30 inside, and a bottom surface of the square frustum is open to form the opening portion 32. In addition, a surface facing the opening portion 32 is closed to form the closing portion 34. The cavity portion 30 is formed in a shape substantially similar to the outer shape of the silencing structure 22. In other words, the cavity portion 30 has a substantially square frustum shape.

Therefore, as shown in FIG. 1, among the surfaces (surfaces other than the closing portion 34) of the silencing structure 22 in contact with the opening portion 32, two surfaces (31a and 31b) facing to each other in the axial direction are inclined with respect to a line segment orthogonal to the central axis Ix of the tubular member 12 as viewed in the transverse cross section.

In addition, as shown in FIG. 2, among the surfaces of the silencing structure 22 in contact with the opening portion 32, remaining two surfaces (31c and 31d) are inclined with respect to a perpendicular line drawn from the center of the tubular member 12 to the surface of the silencing structure 22 on the closing portion side as viewed in the front cross section.

As shown in FIGS. 1 and 2, the silencing structure 22 is disposed on the outer peripheral surface of the tubular member 12 with the opening portion 32 aligned with a position of the connection hole 12a of the tubular member 12. Therefore, a bottom portion (surface on the opening portion 32 side) of the silencing structure 22 is a curved surface along the outer peripheral surface of the tubular member 12.

Here, in the transverse cross section of the silencing structure 22, a width of the cavity portion 30 is narrowed as a distance from the opening portion 32 is increased. That is, a width W₁ of the cavity portion 30 on the opening portion 32 side is wider than a width W₂ on the closing portion 34 side and is gradually narrowed toward the closing portion 34 side.

In addition, in the front cross section of the silencing structure 22, a width of the cavity portion 30 is narrowed as a distance from the opening portion 32 is increased. That is, a width W₃ of the cavity portion 30 on the opening portion 32 side is wider than a width W₄ on the closing portion 34 side and is gradually narrowed toward the closing portion 34 side.

Therefore, a cross-sectional area of the cavity portion 30 on the opening portion 32 side is larger than a cross-sectional area of the cavity portion 30 on the closing portion 34 side.

It should be noted that, regarding the cross-sectional area of the cavity portion 30 on the opening portion 32 side, as shown in FIG. 2, in a case in which a cross-sectional shape of the tubular member 12 is a circular shape or the like and a surface of the silencing structure on the opening portion 32 side is a curved surface, the cross-sectional area of the cavity portion 30 on a tangent plane with the tubular member 12 at the center position of the opening portion 32 is the cross-sectional area of the cavity portion 30 on the opening portion 32 side. Therefore, the width W₃ of the cavity portion 30 on the opening portion 32 side is a width of the cavity portion 30 on a tangent line with the tubular member 12 at the center position of the opening portion 32.

In addition, the cross-sectional area of the cavity portion 30 on the closing portion 34 side is the cross-sectional area of the cavity portion 30 that is parallel to a plane on which the cross-sectional area of the cavity portion 30 on the opening portion 32 side is obtained and that is closed to the closing portion 34 side.

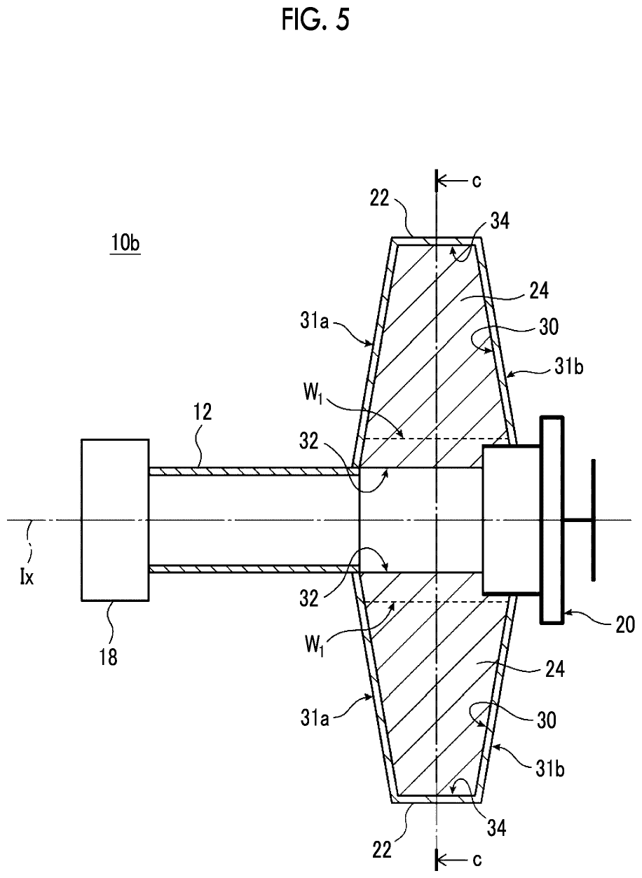

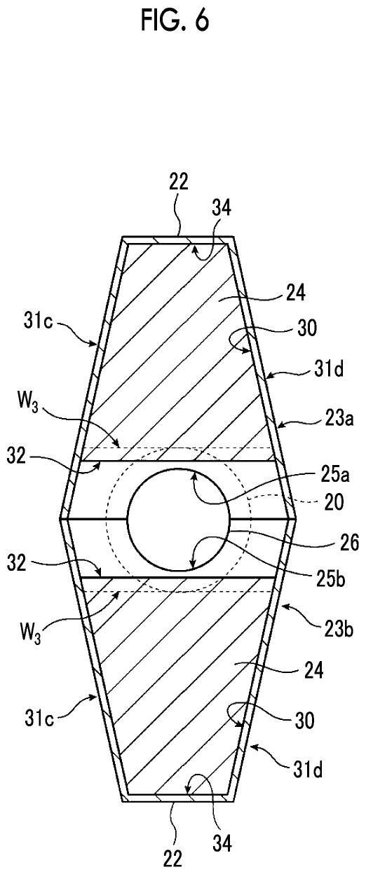

It should be noted that, as shown in FIGS. 5 and 6 described below, the opening portion 32 is narrowed (narrower than the width of the cavity portion 30), for example, in a case in which the opening portion 32 is partially closed by an air volume adjusting member 20, the cross-sectional area of the cavity portion 30 at the position closest to the opening portion 32 is the cross-sectional area of the cavity portion 30 on the opening portion 32 side.

As described above, the silencing structure according to the embodiment of the present invention has the configuration in which, at least one of the cross section (front cross section) perpendicular to the axial direction of the tubular member 12 or the cross section (transverse cross section) parallel to the axial direction of the tubular member 12, the width of the cavity portion 30 is narrowed as the distance from the opening portion 32 is increased, so that the configuration is adopted in which the cross-sectional area of the cavity portion 30 on the opening portion 32 side is larger than the cross-sectional area of the cavity portion 30 on the closing portion 34 side. As a result, a sound absorbance in a low frequency region can be further increased without increasing a volume of the silencing structure.

A mechanism of the effect of capable of increasing the sound absorbance in the low frequency region is estimated as follows.

Since, as the cross-sectional area of the cavity portion 30 on the opening portion 32 side is larger, an acoustic impedance in the vicinity of the opening portion 32 is lower, the sound wave is more likely to enter the silencing structure, and the effect is more likely to occur at a low frequency having a strong diffraction characteristic, it is estimated that the sound absorbance in the low frequency region can be further increased. However, since a sound absorbing effect of a porous sound absorbing material is weakened in the low frequency region, the sound absorbing effect is not higher in the low frequency region than in a high frequency region.

Here, in the examples shown in FIG. 1 and FIG. 2, the configuration is adopted in which the silencing system 10 includes one silencing structure 22, but the present invention is not limited to this, and a configuration may be adopted in which the silencing system 10 includes two or more silencing structures 22. In a case of the configuration in which the silencing system 10 includes the two or more silencing structures 22, the respective silencing structure 22 may be disposed at different positions in a circumferential direction (hereinafter, also simply referred to as the circumferential direction) of the tubular member 12, or may be disposed at different positions in the axial direction of the tubular member 12.

In addition, in the examples shown in FIGS. 1 and 2, the configuration is adopted in which the silencing structure 22 is disposed on the outer peripheral surface of the tubular member 12, but the present invention is not limited to this as long as the silencing structure 22 is disposed at a position at which a sound passing through the tubular member 12 and/or a sound generated by the tubular member 12 can be silenced. For example, the silencing structure 22 may be disposed in the vicinity of an end surface of the tubular member 12. Alternatively, the silencing structure 22 may be disposed inside the tubular member 12.

FIG. 5 shows a cross-sectional view conceptually showing another example of the silencing system according to the embodiment of the present invention. FIG. 6 shows a cross-sectional view taken along the line c-c of FIG. 5.

A silencing system 10b shown in FIGS. 5 and 6 includes the tubular member 12 and two silencing structures 22 disposed at a position at which the outer peripheral portion of the tubular member 12 on one end surface side of the tubular member 12 is extended. In addition, as a preferred aspect, the silencing system 10b includes a soundproof hood 18 disposed on an end surface of the tubular member 12 on a side opposite to the end surface on the side on which the silencing structure 22 is disposed, and the air volume adjusting member 20 disposed at a position of the silencing structure 22 on a side opposite to the tubular member 12, which is a position passing through the central axis Ix of the tubular member 12. In addition, the silencing structure 22 includes a porous sound absorbing material 24 in the cavity portion 30.

The soundproof hood 18 is a louver or the like that is known in the related art and is installed in the ventilation port, the air conditioning duct, or the like. In addition, the air volume adjusting member 20 is a register or the like that is known in the related art.

As shown in FIG. 5, the two silencing structures 22 are disposed at the same position in the axial direction but at different positions in a circumferential direction (positions deviated by 180°).

In addition, as shown in FIG. 6, the two silencing structures 22 are formed as a part of two components (23a and 23b) having a truncated cone shape, by aligning the bottom surfaces of the two components with each other to form a space inside. One component 23a forms one silencing structure 22 and the other component 23b forms the other silencing structure 22.

In the front cross section of the two components (23a and 23b), a width of an end side in contact with the other component is equal to or larger than the diameter of the tubular member 12. In addition, semicircular notches (25a and 25b) having a diameter substantially the same as the diameter of the tubular member 12 are formed at the end parts of the two components (23a and 23b) on a side in contact with the other component of a surface on the tubular member 12. As a result, in a case in which the two components (23a and 23b) are combined, an opening 26 having a diameter substantially the same as the diameter of the tubular member 12 is formed at a position through which the central axis Ix of the tubular member 12 passes. The opening 26 is connected to one end surface of the tubular member 12 and communicates with the inside of the tubular member 12.

On the other hand, semicircular notches into which the air volume adjusting member 20 is fitted are formed respectively on the end parts on the side in contact with the other component of the surface on a side opposite to the tubular member 12 of the two components (23a and 23b), and the opening into which the air volume adjusting member 20 is fitted is formed in a case in which the two components (23a and 23b) are combined.

As a result, the soundproof hood 18, the tubular member 12, the two components (23a and 23b), and the air volume adjusting member 20 are in a state of communicating with each other, so that the ventilation can be performed between the soundproof hood 18 side and the air volume adjusting member 20 side. In other words, the two components (23a and 23b) also function as a part of the tubular member.

Here, also in the examples shown in FIGS. 5 and 6, in the transverse cross section of the silencing structure 22, the width of the cavity portion 30 is narrowed as a distance from the opening portion 32 is increased. That is, the width W₁ of the cavity portion 30 on the opening portion 32 side is wider than the width W₂ on the closing portion 34 side and is gradually narrowed toward the closing portion 34 side.

In addition, in the front cross section of the silencing structure 22, the width of the cavity portion 30 is narrowed as the distance from the opening portion 32 is increased. That is, the width W₃ of the cavity portion 30 on the opening portion 32 side is wider than the width W₄ on the closing portion 34 side and is gradually narrowed toward the closing portion 34 side.

Therefore, the cross-sectional area of the cavity portion 30 on the opening portion 32 side is larger than the cross-sectional area of the cavity portion 30 on the closing portion 34 side.

As a result, the sound absorbance in the low frequency region can be further increased without increasing the volume of the silencing structure.

Here, in the example shown in FIG. 3 or the like, the shape of the silencing structure 22 (cavity portion 30) is the substantially square frustum shape, in a configuration is adopted in which the cross-sectional area of the cavity portion 30 on the opening portion 32 side is larger than the cross-sectional area of the cavity portion 30 on the closing portion 34 side, a configuration may be adopted in which the width of the cavity portion 30 is narrowed as the distance from the opening portion 32 is increased in at least one of the cross section (front cross section) perpendicular to the axial direction of the tubular member 12 or the cross section (transverse cross section) parallel to the axial direction of the tubular member 12.

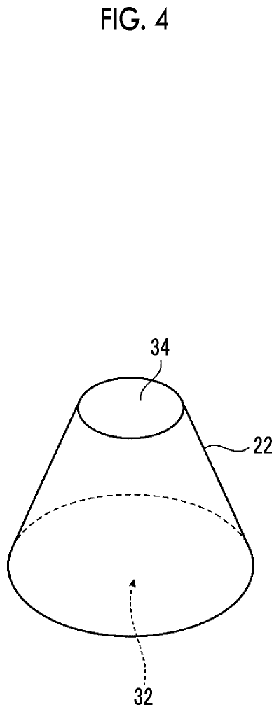

For example, as shown in FIG. 4, the shape of the silencing structure 22 (cavity portion 30) may be a substantially truncated cone shape, a polygonal frustum shape, or the like. In addition, in the various shapes described above, a side surface (surface other than the surface having the opening portion and the closing portion) may be an outwardly protrusion curved surface or an outwardly recess curved surface.

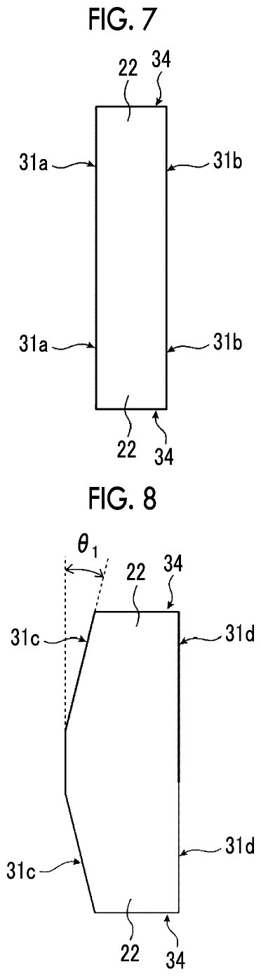

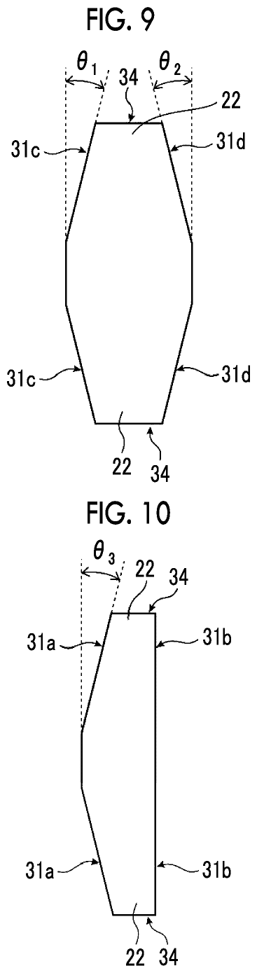

Alternatively, the shape of the silencing structure 22 (cavity portion 30) may be a shape in which any one of the side surfaces of the square pillar of the trapezoid is used as the opening portion. Specifically, for example, in the shape of the silencing structure 22 (cavity portion 30), the shape of the transverse cross section may be a rectangular shape in which the surface 31a and the surface 31b are not inclined as shown in FIG. 7, and the shape of the front cross section may be a trapezoidal shape in which the surface 31c is inclined and the surface 31d is not inclined as shown in FIG. 8. It should be noted that FIG. 7 is a diagram schematically showing the shape of the transverse cross section in a case in which the two silencing structures 22 are provided, as in FIG. 5, and FIG. 8 is a diagram schematically showing the shape of the front cross section in a case in which the two silencing structures 22 are provided, as in FIG. 6. The same applies to FIGS. 9 to 12. In addition, in the example shown in FIG. 8, the trapezoidal shape is adopted in which the surface 31c is inclined and the surface 31d is not inclined, but a trapezoidal shape may be adopted in which the surface 31d is inclined and the surface 31c is not inclined. In this example, in the cross section (front cross section) perpendicular to the axial direction of the tubular member, the width of the cavity portion is narrowed as the distance from the opening portion is increased.

Alternatively, for example, in the shape of the silencing structure 22 (cavity portion 30), the shape of the transverse cross section may be the rectangular shape in which the surface 31a and the surface 31b are not inclined as shown in FIG. 7, and the shape of the front cross section may be a trapezoidal shape in which the surface 31c and the surface 31d are inclined as shown in FIG. 9. In this example, in the cross section (front cross section) perpendicular to the axial direction of the tubular member, the width of the cavity portion is narrowed as the distance from the opening portion is increased. An inclination angle θ₁ of the surface 31c and an inclination angle θ₂ of the surface 31d may be the same as or different from each other.

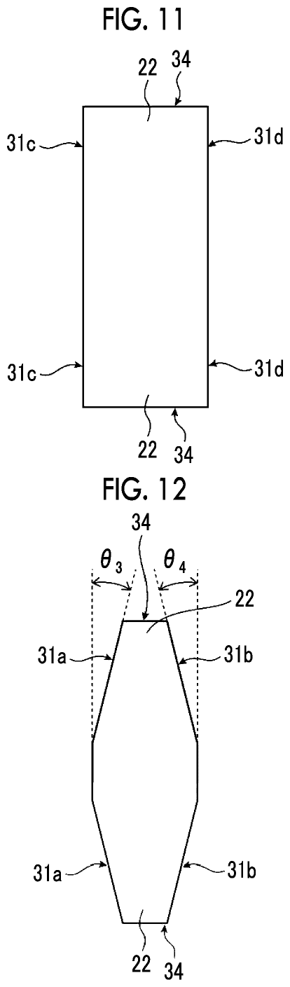

Alternatively, for example, in the shape of the silencing structure 22 (cavity portion 30), the shape of the transverse cross section may be a trapezoidal shape in which the surface 31a is inclined and the surface 31b is not inclined as shown in FIG. 10, and the shape of the front cross section may be a rectangular shape in which the surface 31c and the surface 31d are not inclined as shown in FIG. 11. It should be noted that, in the example shown in FIG. 10, the trapezoidal shape is adopted in which the surface 31a is inclined and the surface 31b is not inclined, but a trapezoidal shape may be adopted in which the surface 31b is inclined and the surface 31a is not inclined. In this example, in the cross section (transverse cross section) parallel to the axial direction of the tubular member, the width of the cavity portion is narrowed as the distance from the opening portion is increased.

Alternatively, for example, in the shape of the silencing structure 22 (cavity portion 30), the shape of the transverse cross section may be a trapezoidal shape in which the surface 31a and the surface 31b are inclined as shown in FIG. 12, and the shape of the front cross section may be the rectangular shape in which the surface 31c and the surface 31d are not inclined as shown in FIG. 11. In this example, in the cross section (transverse cross section) parallel to the axial direction of the tubular member, the width of the cavity portion is narrowed as the distance from the opening portion is increased. An inclination angle θ₃ of the surface 31a and an inclination angle θ₄ of the surface 31b may be the same as or different from each other.

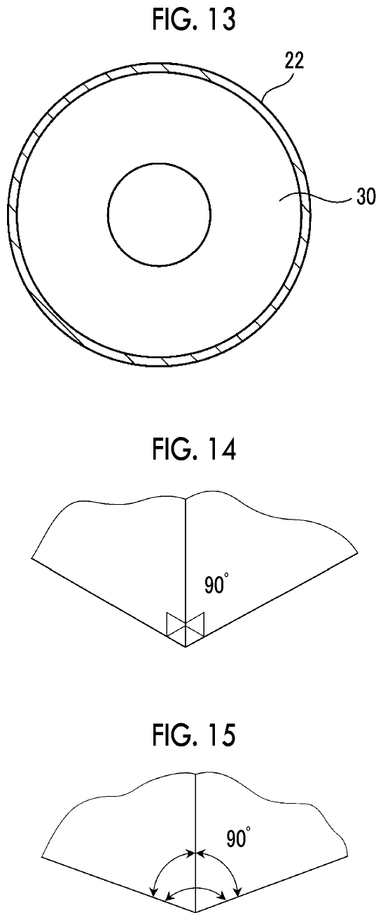

Also, as shown in FIG. 13, the shape of the front cross section of the silencing structure 22 (cavity portion 30) may be an annular shape (donut shape). In this case, the shape of the transverse cross section may be the trapezoidal shape in which the surface 31a is inclined and the surface 31b is not inclined as shown in FIG. 10, or may be the trapezoidal shape in which the surface 31a and the surface 31b are inclined as shown in FIG. 12. In this example, in the cross section (transverse cross section) parallel to the axial direction of the tubular member, the width of the cavity portion is narrowed as the distance from the opening portion is increased.

Here, in a case of a related-art cube-shaped silencer in which the width of the cavity portion is constant, as shown in FIG. 14, angles formed by line segments that are in contact with a vertex of the cavity portion that is not in contact with the opening portion both are approximately 90°.

On the other hand, since the silencing structure according to the embodiment of the present invention has the configuration in which the width of the cavity portion is narrowed as the distance from the opening portion is increased in at least one of the cross section (front cross section) perpendicular to the axial direction of the tubular member or the cross section (transverse cross section) parallel to the axial direction of the tubular member, at least one angle formed by the line segments that are in contact with the vertex of the cavity portion that is not in contact with the opening portion is larger than 90° (π/2 [rad]), as shown in FIG. 15.

Here, another action of the silencing structure according to the embodiment of the present invention will be described below.

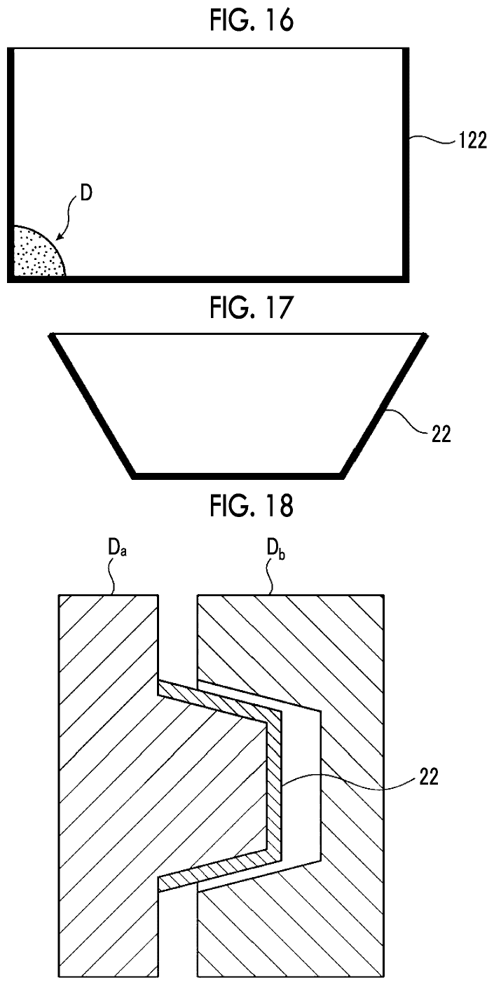

As described above, in a case of the related-art cube-shaped silencer, the angles formed by the line segments that are in contact with the vertex of the cavity portion that is not in contact with the opening portion is approximately 90°. Therefore, as shown in FIG. 16, the dirt, the mildew, and the like (reference numeral D) are likely to accumulate in a corner portion of the cavity portion on the side that is not in contact with the opening portion. In addition, it is difficult to remove the dirt, the mildew, and the like.

On the other hand, in the silencing structure according to the embodiment of the present invention, at least one angle formed by the line segments that are in contact with the vertex of the cavity portion that is not in contact with the opening portion is larger than 90°. Therefore, as shown in FIG. 17, the dirt, the mildew, and the like are less likely to accumulate in the corner portion of the cavity portion on the side that is not in contact with the opening portion. In addition, it is easy to remove the dirt, the mildew, and the like. In addition, moisture is less likely to accumulate in the corner portion and is likely to dry.

In addition, the silencing structure according to the embodiment of the present invention has the configuration in which the width of the cavity portion is narrowed as the distance from the opening portion is increased in at least one of the cross section (front cross section) perpendicular to the axial direction of the tubular member or the cross section (transverse cross section) parallel to the axial direction of the tubular member, and at least one of the surfaces (31a to 31d) that are in contact with the opening portion is inclined. Therefore, as shown in FIG. 18, in a case in which the silencing structure 22 is manufactured by using molds (Da and db) as in injection molding or the like, since the surface in contact with the opening portion is inclined, there is a gradient, and the silencing structure 22 can be easily released from the mold after mold. In addition, since the silencing structure 22 can be appropriately manufactured by injection molding, the silencing structure 22 can be manufactured easily and at low cost as compared with a case in which the silencing structure 22 is manufactured by another processing method such as cutting.

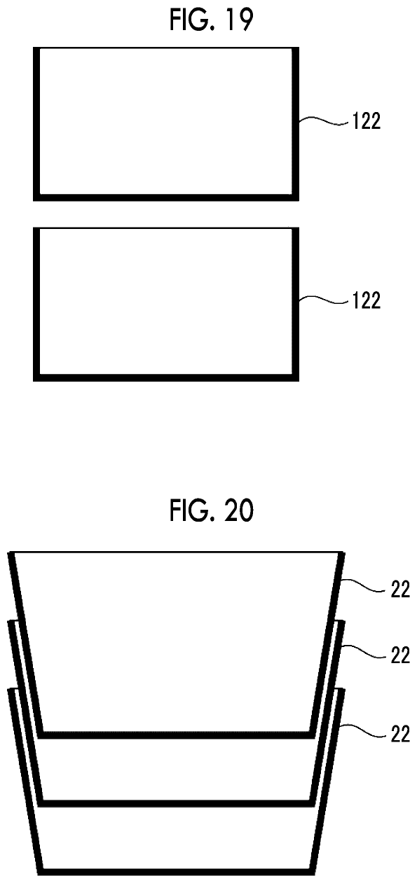

In addition, in a case of the related-art cube-shaped silencer, as shown in FIG. 19, a plurality of silencers 122 having the same shape cannot be superimposed on each other. Therefore, the volume is increased during transportation or the like, and the transportation efficiency is deteriorated.

On the other hand, in the silencing structure according to the embodiment of the present invention, at least one of the surfaces (31a to 31d) that are in contact with the opening portion is inclined, and thus the plurality of silencing structures 22 having the same shape can be superimposed on each other, as shown in FIG. 20. Therefore, the volume can be reduced during transportation or the like, and the transportation efficiency can be improved.

In addition, from the viewpoints that the sound absorbance in the low frequency region can be further increased, the mold release of the molding can be facilitated, the transportation efficiency can be improved, and the dirt, the mildew, and the like are less likely to accumulate in the corner portion, a total angle of the inclination angle θ₁ of the surface 31c and the inclination angle θ₂ of the surface 31d and a total angle of the inclination angle θ₃ of the surface 31a and the inclination angle θ₄ of the surface 31b are preferably in a range of 0.1° to 20°, more preferably in a range of 1° to 16°, and still more preferably in a range of 2° to 12°.

In addition, the area of the opening portion, a height of the cavity portion, and the like need only be appropriately set according to a silencing mechanism of the silencing structure, the frequency band to be silenced, and the like.

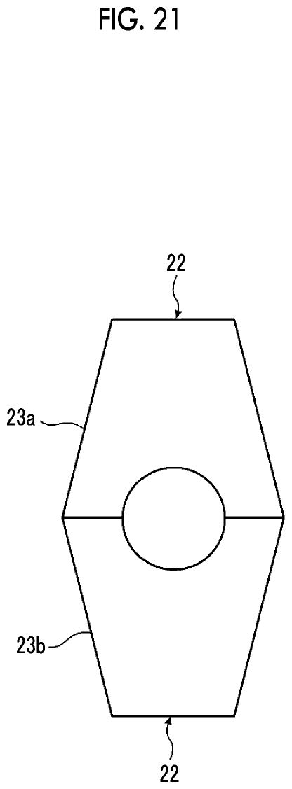

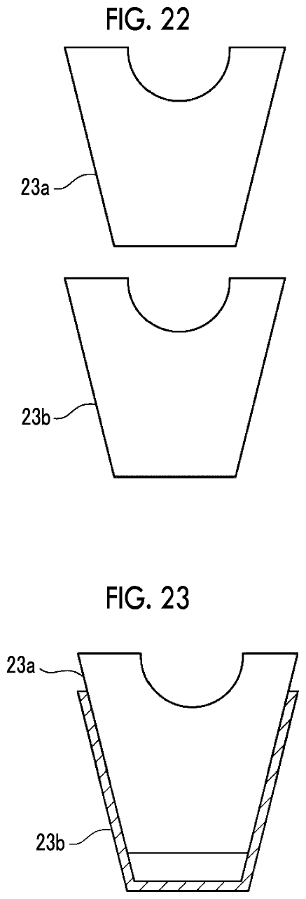

Here, in the configuration including two or more silencing structures as in the example shown in FIG. 5, in a case in which the respective silencing structures consist of the components (23a and 23b) having the same shape as shown in FIG. 21, the component 23a and the component 23b can be separated (see FIG. 22) and superimposed as shown in FIG. 23. Therefore, the volume can be reduced during transportation or the like, and the transportation efficiency can be improved. In addition, in a case in which the respective silencing structures consist of the component having the same shape, the mold can be shared, so that the cost can be reduced.

In addition, in the configuration including the two or more silencing structures, it is also preferable that at least two silencing structures are formed by one mold. In this case, the two silencing structures may have different shapes. By sharing the mold, the cost can be reduced.

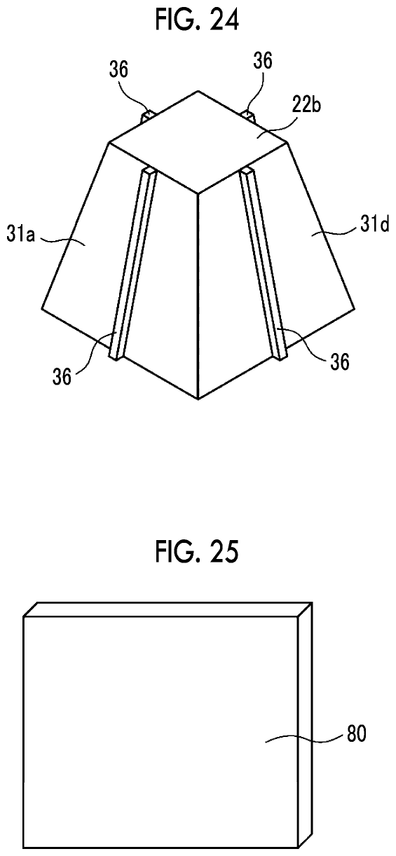

Also, it is preferable that the silencing structure according to the embodiment of the present invention has a rib structure. FIG. 24 shows another example of the silencing structure according to the embodiment of the present invention. A silencing structure 22b shown in FIG. 24 has a rib structure 36 on each of the surfaces (31a to 31d) adjacent to the opening portion.

Since the component constituting the silencing structure is not a completely rigid body, for example, there is a concern that one surface constituting the silencing structure may vibrate to transmit sound. On the other hand, by applying the rib structure to the silencing structure and increasing the rigidity of each part of the silencing structure, the resonance frequency of the component constituting the silencing structure can be increased, and the sound absorption property in the low frequency region can be improved.

This point will be described with reference to FIGS. 25 to 29.

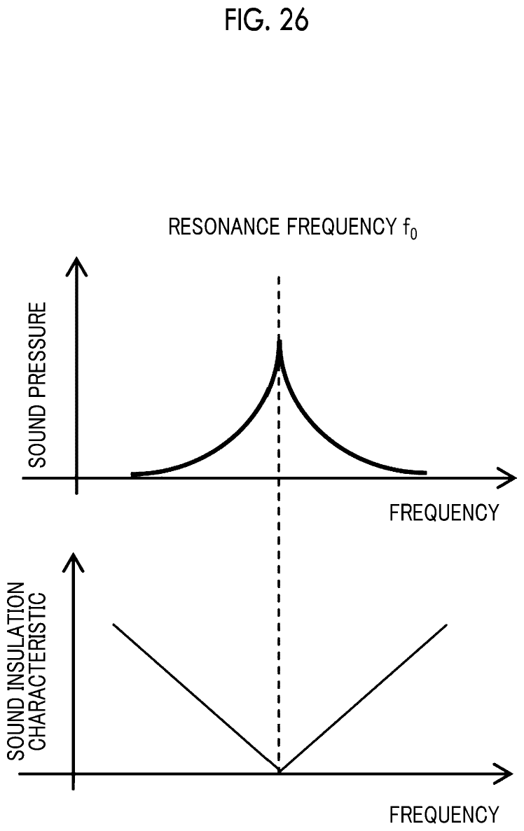

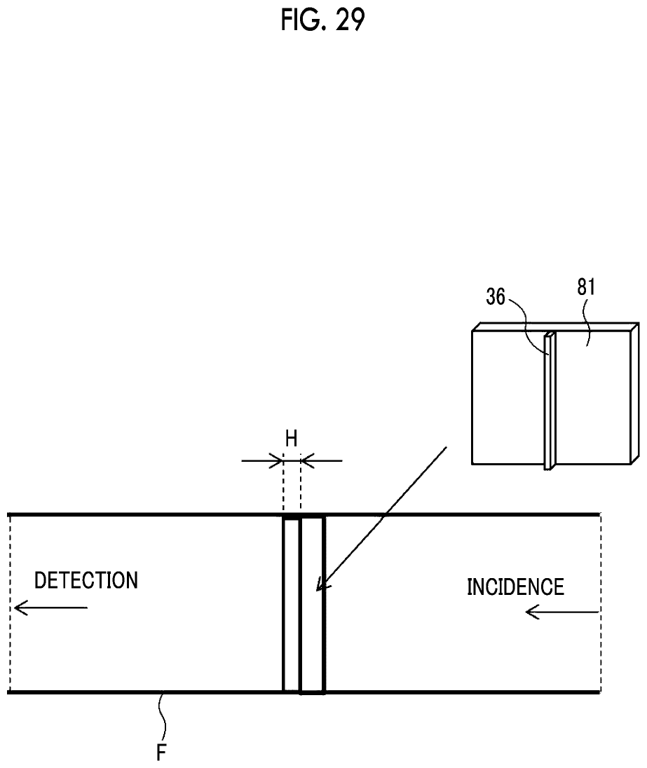

FIG. 25 is a flat plate 80 that has no rib structure. As shown in FIG. 29, in a case in which such a plate 80 is disposed inside a cylindrical member F, the sound wave is incident from one end part of the cylindrical member F, and the sound pressure is measured at the other end part, as schematically shown in an upper graph of FIG. 26, the sound pressure at a resonance frequency f₀ of the plate 80 is increased, and the sound pressure is lowered as the distance from the resonance frequency f₀ is increased. That is, as schematically shown in a lower graph of FIG. 26, the sound insulation characteristic of the plate 80 is lowered at the resonance frequency f₀.

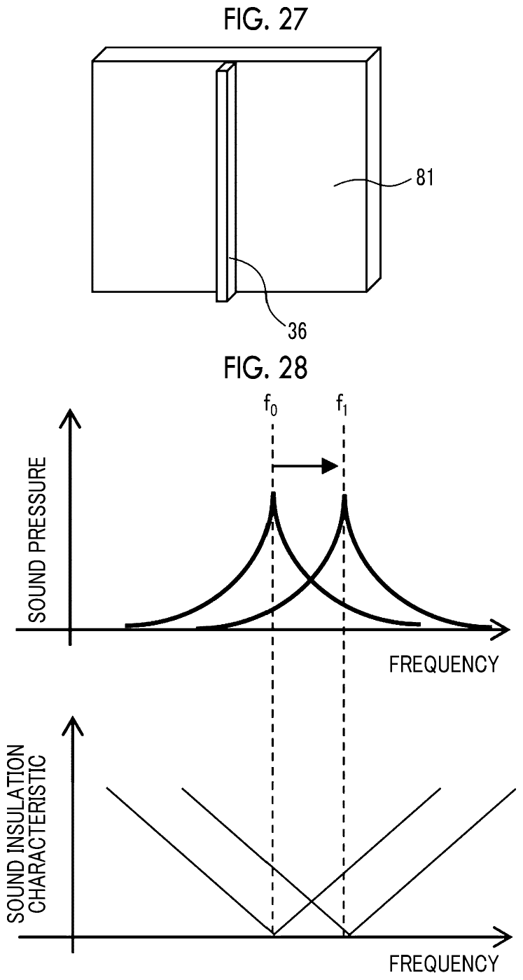

On the other hand, as shown in FIG. 27, in a case of the plate 81 to which the rib structure 36 is applied, as schematically shown in an upper graph of FIG. 28, the resonance frequency of the plate 81 is moved to the high frequency side, the sound pressure is increased at a frequency f₁, and the sound pressure is lowered as the distance from the resonance frequency f₁ is increased. That is, as schematically shown in a lower graph of FIG. 28, the sound insulation characteristic of the plate 81 is lowered at the resonance frequency f₁ higher than the resonance frequency f₀ of the flat plate 80. In this case, since the sound insulation characteristic is improved as the distance from the resonance frequency is increased, the sound insulation characteristic in the low frequency region is higher in the plate 81 to which the rib structure 36 is applied.

Therefore, by applying the rib structure to the silencing structure and increasing the rigidity of each part of the silencing structure, the resonance frequency of the component constituting the silencing structure can be increased, and the sound absorption property in the low frequency region can be improved.

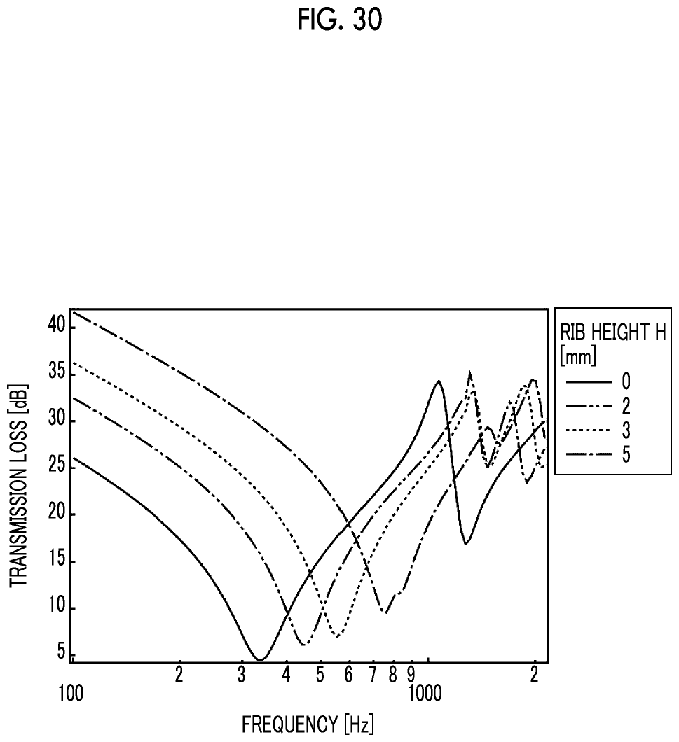

FIG. 30 shows a graph in which a relationship between the frequency and a transmission loss is obtained by changing a height of the rib structure using a calculation model having the configuration as shown in FIG. 29. It should be noted that, in the calculation model, the cylindrical member F has an opening area of 10 cm×10 cm and a length of 30 cm. The plate 81 has a size of 10 cm×10 cm and a thickness of 2 mm. A rib height H is calculated at 0 mm, 2 mm, 3 mm, and 5 mm, respectively. For a simulation, an acoustic module of the finite element method calculation software COMSOL ver5.5 (COMSOL) is used.

As shown in FIG. 30, it can be seen that as the rib height H is larger, the frequency at which the transmission loss is decreased is higher, and the transmission loss in the low frequency region is higher.

It should be noted that, in the example shown in FIG. 24, the configuration is adopted in which the rib structure is disposed to extend in a height direction of the surface adjacent to the opening portion, but the present invention is not limited to this, and the rib structure may be disposed to extend in a width direction of the surface adjacent to the opening portion or may be disposed obliquely.

In addition, in the example shown in FIG. 24, the rib structure is applied to each surface adjacent to the opening portion one by one, but the present invention is not limited to this, and a plurality of rib structures may be applied to each surface.

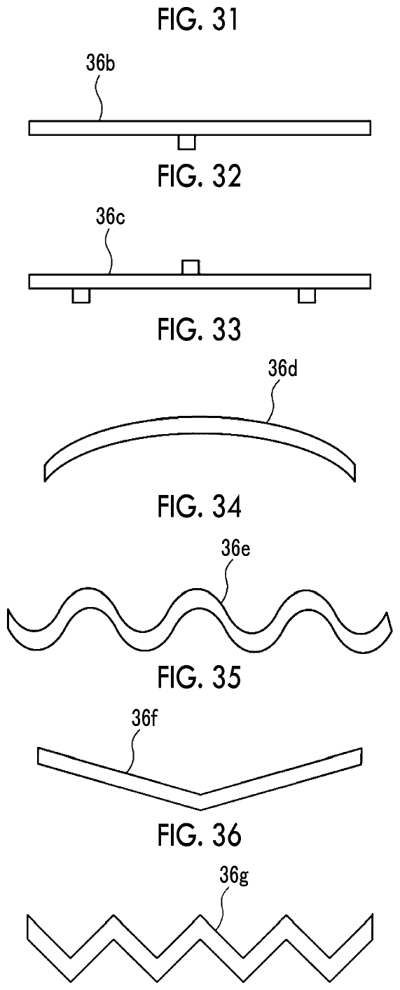

In addition, in the example shown in FIG. 24, the rib structure has a linear shape, but the present invention is not limited to this. For example, as shown in FIG. 31 and FIG. 32, the rib structure may be a branched structure. Alternatively, as shown in FIG. 33, the rib structure may have curved shape. Alternatively, as shown in FIG. 34, the rib structure may have a wavy shape. Alternatively, as shown in FIG. 35, the rib structure may have a shape bent in the middle. Alternatively, as shown in FIG. 36, the rib structure may have a triangular wave shape.

In addition, a shape, a position, the number, and the like of the rib structure may be the same or different for each surface.

Examples of a material for forming the silencing structure include a metal material, a resin material, a reinforced plastic material, and a carbon fiber. Examples of the metal material include metal materials, such as aluminum, titanium, magnesium, tungsten, iron, steel, chromium, chromium molybdenum, nichrome molybdenum, and alloys thereof. In addition, examples of the resin material include resin materials, such as an acrylic resin, polymethyl methacrylate, polycarbonate, polyamide-imide, polyarylate, polyetherimide, polyacetal, polyether ether ketone, polyphenylene sulfide, polysulfone, polyethylene terephthalate, polybutylene terephthalate, polyimide, and triacetyl cellulose. Also, examples of the reinforced plastic material include carbon fiber reinforced plastics (CFRP) and glass fiber reinforced plastics (GFRP).

From the viewpoint of weight reduction, it is preferable to use the resin material as the material of the silencing structure. Also, as described above, from the viewpoint of sound insulation in the low frequency region, it is preferable to use a material having high rigidity. From the viewpoints of weight reduction and sound insulation, it is preferable that a density of the members constituting the silencing structure is 0.5 g/cm³ to 2.5 g/cm³.

As described above, the silencing structure according to the embodiment of the present invention may include the porous sound absorbing material in the cavity portion.

The porous sound absorbing material is not particularly limited, and the sound absorbing material that is known in the related art can be appropriately used. For example, various known sound absorbing material can be used, such as foam materials and materials containing minute air such as urethane foam, soft urethane foam, wood, ceramic particle sintered material, and phenol foam; fibers and nonwoven fabric materials such as glass wool, rock wool, microfibers (Thinsulate manufactured by 3M), a floor mat, a carpet, a meltblown nonwoven fabric, a metal nonwoven fabric, a polyester nonwoven fabric, metal wool, felt, an insulation board and a glass nonwoven fabric; wood wool cement board; nanofiber materials such as silica nanofiber; and gypsum board.

As described above, in the silencing system having the silencing structure according to the embodiment of the present invention, the disposition of the silencing structure with respect to the tubular member is not particularly limited as long as the sound can be appropriately silenced at the position, but it is preferable that the silencing structure is disposed not to occupy 50% or more of the cross-sectional area perpendicular to the axial direction of the tubular member. As a result, the ventilation property of the tubular member can be ensured.

Further, the silencing structure according to the embodiment of the present invention may have another commercially available soundproof member.

For example, in addition to the silencer according to the embodiment of the present invention, an insertion type silencer installed inside the ventilation sleeve may be provided, or an outdoor-installation type silencer installed in the end part of the ventilation sleeve may be provided.

By combining with the other soundproof member, high soundproof performance can be obtained in a wider band.

### Examples

Hereinafter, the present invention will be described in more detail based on Examples. A material, a usage amount, a ratio, a processing content, a processing procedure, and the like shown in Examples can be appropriately changed without departing from the spirit of the present invention. Accordingly, the scope of the present invention should not be construed as being limited by Examples.

[Simulation 1]

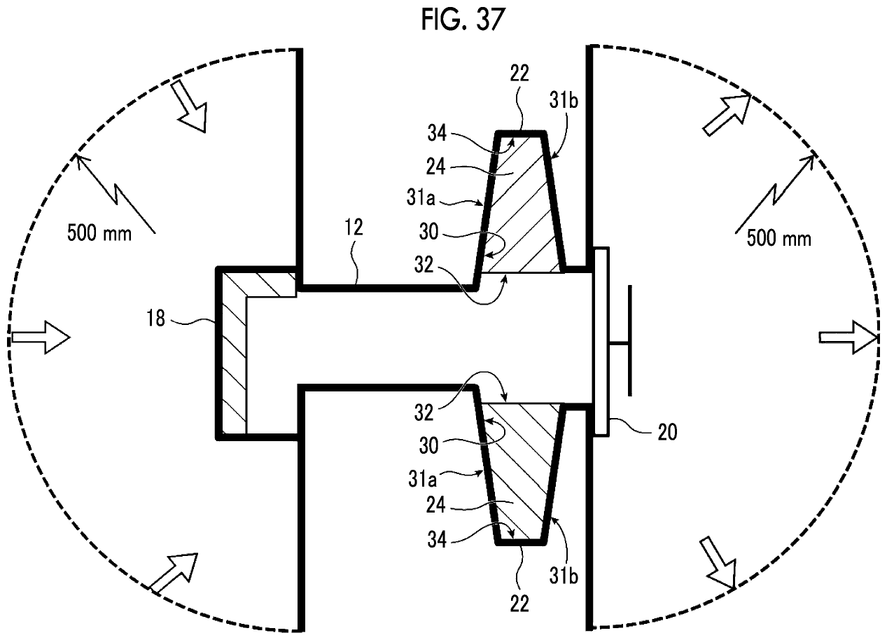

As a simulation 1, as shown in FIG. 37, a simulation was performed on a configuration in which the two silencing structures 22 were disposed on the outer peripheral surface of the tubular member 12. In addition, the porous sound absorbing material 24 was disposed in the cavity portion of the silencing structure 22.

In addition, a configuration was adopted in which the soundproof hood 18 was disposed on the opening surface of the tubular member 12 on a side opposite to the side on which the silencing structure 22 was installed, and the register (air volume adjusting member) was disposed on the surface of the silencing structure 22 on a side opposite to the tubular member 12. As the soundproof hood, a soundproof hood (BON-TS) manufactured by SYLPHA Corporation was modeled. As the register, a register (KRP-BWF) manufactured by UNIX Co., Ltd. was modeled.

The inner diameter of the tubular member 12 was 100 mm, and the length thereof was 300 mm. The height of the cavity portion of the silencing structure 22 from the inner diameter of the tubular member 12 was 220 mm.

In addition, the entire area of the cavity portion 30 was filled with the porous sound absorbing material 24. A flow resistance of the porous sound absorbing material 24 was 2650 [Pa·s/m²].

In addition, a diameter of a portion of the register to be inserted into the silencing structure was 150 mm.

The transverse cross section of the silencing structure 22 had the rectangular shape in which the surface 31a and the surface 31b were not inclined as shown in FIG. 7, the front cross section had the shape in which the surface 31c was inclined at the inclination angle θ₁ and the surface 31d was not inclined as shown in FIG. 8, the inclination angle θ₁ of the surface 31c was changed to each of 0°, 2°, 6°, and 10°. A case in which the inclination angle θ₁ was 0° is Comparative Example, and cases in which the inclination angle θ₁ was 2°, 6°, and 10° are Examples.

It should be noted that the width of the cavity portion in the transverse cross section was 86 mm, the width of the cavity portion in the front cross section was 251 mm in a case in which the inclination angle θ₁ of the surface 31c was 0°, and the width the cavity portion (opening portion) was adjusted such that the volume of the cavity portion was constant in a case in which the inclination angle of the surface 31c was changed. In a case in which the inclination angle θ₁ was 2°, the cavity portion had the width W₃ on the opening portion side that was 253 mm and the cross-sectional area that was 21578 mm², and had the width W₄ on the closing portion side that was 246.5 mm and the cross-sectional area that was 21199 mm². In a case in which the inclination angle θ₁ was 6°, the cavity portion had the width W₃ on the opening portion side that was 258 mm and the cross-sectional area that was 22188 mm², and had the width W₄ on the closing portion side that was 237.5 mm and the cross-sectional area that was 20425 mm². In a case in which the inclination angle θ₁ was 10°, the width W₃ of the cavity portion on the opening portion side was 263.5 mm and the cross-sectional area was 22661 mm², and the width W₄ on the closing portion side was 229.5 mm and the cross-sectional area was 19737 mm².

As shown in FIG. 37, using such a simulation model, the sound wave was incident from a hemispherical surface in one space, and the amplitude of the sound wave reaching the hemispherical surface in the other space was obtained per unit volume. The hemispherical surface was a hemispherical surface having a radius of 500 mm about the center position of the opening surface of the tubular member. The amplitude of the incident sound wave per unit volume was 1.

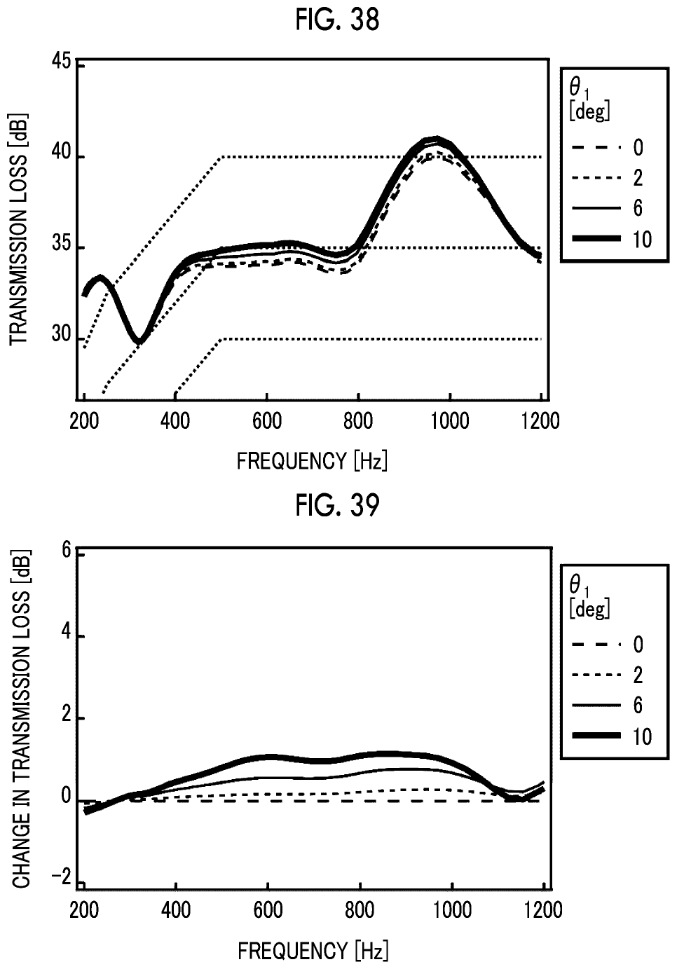

The results are shown in FIG. 38 as a graph showing the relationship between the frequency and the transmission loss. In addition, FIG. 39 shows a change amount of the transmission loss in a case in which the inclination angle θ₁ was 0°, as a graph. As shown in FIGS. 38 and 39, in a band between the frequencies of 300 Hz and 1100 Hz, in a case in which the inclination angle θ₁ was 2° to 10°, the transmission loss was increased as compared with a case in which the inclination angle θ₁ was 0°. That is, it can be seen that the sound absorption property in the low frequency region was improved.

[Simulation 2]

In a simulation 2, a simulation was performed in the same manner as in the simulation 1 except that, as shown in FIG. 9, the front cross section of the silencing structure 22 had the shape in which the surface 31c was inclined at the inclination angle θ₁ and the surface 31d was inclined at the inclination angle θ₂, and the inclination angles θ₁ and θ₂ were changed to each of 0°, 2°, 6°, and 10°. A case in which the inclination angles θ₁ and θ₂ were 0° is Comparative Example, and cases in which the inclination angles θ₁ and θ₂ were 2°, 6°, and 10° are Examples.

It should be noted that the width of the cavity portion in the front cross section was 251 mm in a case in which the inclination angle θ₁ of the surface 31c and the inclination angle θ₂ of the surface 31d were 0°, and the width of the cavity portion was adjusted such that the volume of the cavity portion was constant in a case in which the inclination angles θ₁ and θ₂ was changed. In a case in which the inclination angles θ₁ and θ₂ were 2°, the cavity portion had the width W₃ on the opening portion side that was 255 mm and the cross-sectional area that was 21930 mm², and had the width W₄ on the closing portion side that was 242 mm and the cross-sectional area that was 20812 mm². In a case in which the inclination angles θ₁ and θ₂ were 6°, the cavity portion had the width W₃ on the opening portion side that was 265 mm and the cross-sectional area that was 22790 mm², and had the width W₄ on the closing portion side that was 224 mm and the cross-sectional area that was 19264 mm². In a case in which the inclination angles θ₁ and θ₂ were 10°, the cavity portion had the width W₃ on the opening portion side that was 276 mm and the cross-sectional area that was 23736 mm², and had the width W₄ on the closing portion side that was 208 mm and the cross-sectional area that was 17888 mm².

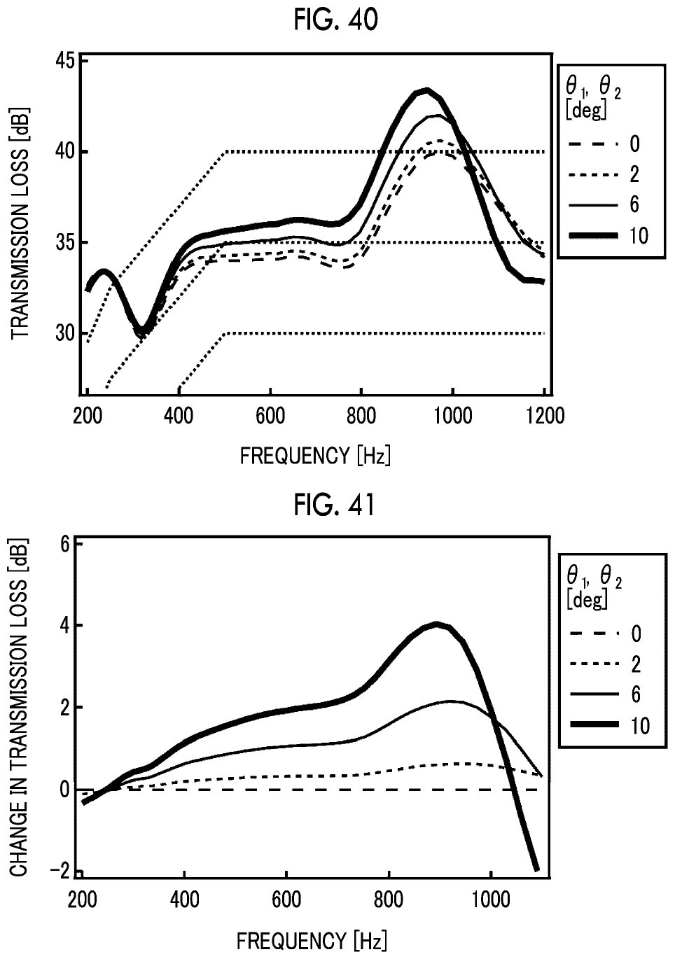

The results are shown in FIG. 40 as a graph showing the relationship between the frequency and the transmission loss. In addition, FIG. 41 shows a change amount of the transmission loss in a case in which the inclination angles θ₁ and θ₂ were 0°, as a graph. As shown in FIGS. 40 and 41, in a band between the frequencies of 300 Hz and 1100 Hz, in a case in which the inclination angles θ₁ and θ₂ were 2° to 10°, the transmission loss was increased as compared with a case in which the inclination angles θ₁ and θ₂ were 0°. That is, it can be seen that the sound absorption property in the low frequency region was improved.

[Simulation 3]

In a simulation 3, a simulation was performed in the same manner as in the simulation 1 except that, as shown in FIG. 12, the transverse cross section of the silencing structure 22 has the shape in which the surface 31a was inclined at the inclination angle θ₃ and the surface 31b was inclined at the inclination angle θ₄, and as shown in FIG. 9, the front cross section of the silencing structure 22 had the shape in which the surface 31c was inclined at the inclination angle θ₁ and the surface 31d was inclined at the inclination angle θ₂, and the inclination angles θ₁ to θ₄ were changed to each of 0°, 2°, 6°, and 10°. A case in which the inclination angles θ₁ to θ₄ were 0° is Comparative Example, and cases in which the inclination angles θ₁ to θ₄ were 2°, 6°, and 10° are Examples.

It should be noted that the width of the cavity portion in the transverse cross section was 86 mm in a case in which the inclination angle θ₃ of the surface 31a and the inclination angle θ₄ of the surface 31b were 0°, and the inclination angles θ₃ and θ₄ were changed. In this case, the width W₁ and the width W₂ were adjusted such that the width at the center position in the height direction was constant. Similarly, the width of the cavity portion in the front cross section was 251 mm in a case in which the inclination angle θ₁ of the surface 31c and the inclination angle θ₂ of the surface 31d were 0°, and the width W₃ and the width W₄ of the cavity portion in the front cross section were adjusted such that the width at the center position in the height direction was constant in a case in which the inclination angles θ₁ and θ₂ were changed. In a case in which the inclination angles θ₁ to θ₄ were 2°, the cavity portion had the width W₁ on the opening portion side that was 90 mm and the width W₂ on the closing portion side that was 77 mm in the transverse cross section, and the cavity portion had the width W₃ on the opening portion side that was 255 mm and the width W₄ on the closing portion side that was 242 mm in the front cross section. Therefore, the cross-sectional area of the cavity portion on the opening portion side was 22950 mm², and the cross-sectional area of the cavity portion on the closing portion side was 18634 mm². In a case in which the inclination angles θ₁ to θ₄ were 6°, the cavity portion had the width W₁ on the opening portion side that was 100 mm and the width W₂ on the closing portion side that was 59 mm in the transverse cross section, and the cavity portion had the width W₃ on the opening portion side that was 265 mm and the width W₄ on the closing portion side that was 224 mm in the front cross section. Therefore, the cross-sectional area of the cavity portion on the opening portion side was 13216 mm², and the cross-sectional area of the cavity portion on the closing portion side was 26500 mm². In a case in which the inclination angles θ¹ to θ₄ were 10°, the cavity portion had the width W₁ on the opening portion side that was 110 mm and the width W₂ on the closing portion side that was 42 mm in the transverse cross section, and the cavity portion had the width W₃ on the opening portion side that was 276 mm and the width W₄ on the closing portion side that was 208 mm in the front cross section. Therefore, the cross-sectional area of the cavity portion on the opening portion side was 30360 mm², and the cross-sectional area of the cavity portion on the closing portion side was 8736 mm².

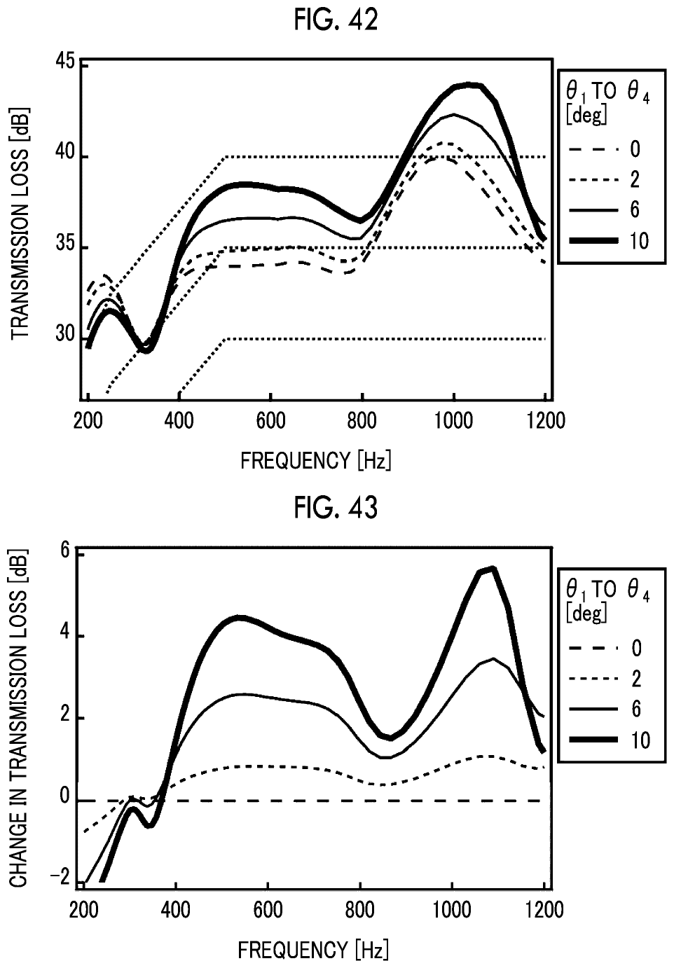

The results are shown in FIG. 42 as a graph showing the relationship between the frequency and the transmission loss. In addition, FIG. 43 shows a change amount of the transmission loss in a case in which the inclination angles θ₁ and θ₂ were 0°, as a graph. As shown in FIGS. 42 and 43, in a band between the frequencies of 400 Hz and 1200 Hz, in a case in which the inclination angles θ₁ to θ₄ were 2° to 10°, the transmission loss was increased as compared with a case in which the inclination angles θ₁ to θ₄ were 0°. That is, it can be seen that the sound absorption property in the low frequency region was improved.

[Simulation 4]

In a simulation 4, a simulation was performed in the same manner as in the simulation 1 except that, as shown in FIG. 10, the transverse cross section of the silencing structure 22 has the shape in which the surface 31a was inclined at the inclination angle θ₃ and the surface 31b was not inclined, and as shown in FIG. 11, the front cross section of the silencing structure 22 had the rectangular shape in which the surface 31c and the surface 31d were not inclined, and the inclination angle θ₃ was changed to each of 0°, 2°, 6°, and 10°. A case in which the inclination angle θ₃ was 0° is Comparative Example, and cases in which the inclination angle θ₃ was 2°, 6°, and 10° are Examples.

It should be noted that the width of the cavity portion in the transverse cross section was 86 mm in a case in which the inclination angle θ₃ of the surface 31a was 0°, and the width of the cavity portion (opening portion) was adjusted such that the volume of the cavity portion was constant in a case in which the inclination angles θ₃ was changed. The width of the cavity portion in the front cross section was 251 mm. In a case in which the inclination angle θ₃ was 2°, the cavity portion had the width W₁ on the opening portion side that was 88 mm and the cross-sectional area that was 22088 mm², and had the width W₂ on the closing portion side that was 82 mm and the cross-sectional area that was 20457 mm². In a case in which the inclination angle θ₃ was 6°, the cavity portion had the width W₁ on the opening portion side that was 93 mm and the cross-sectional area that was 23343 mm², and had the width W₃ on the closing portion side that was 72.5 mm and the cross-sectional area that was 18198 mm². In a case in which the inclination angle θ₃ was 10°, the cavity portion had the width W₁ on the opening portion side that was 98 mm and the cross-sectional area that was 24598 mm², and had the width W₂ on the closing portion side that was 64 mm and the cross-sectional area that was 16064 mm².

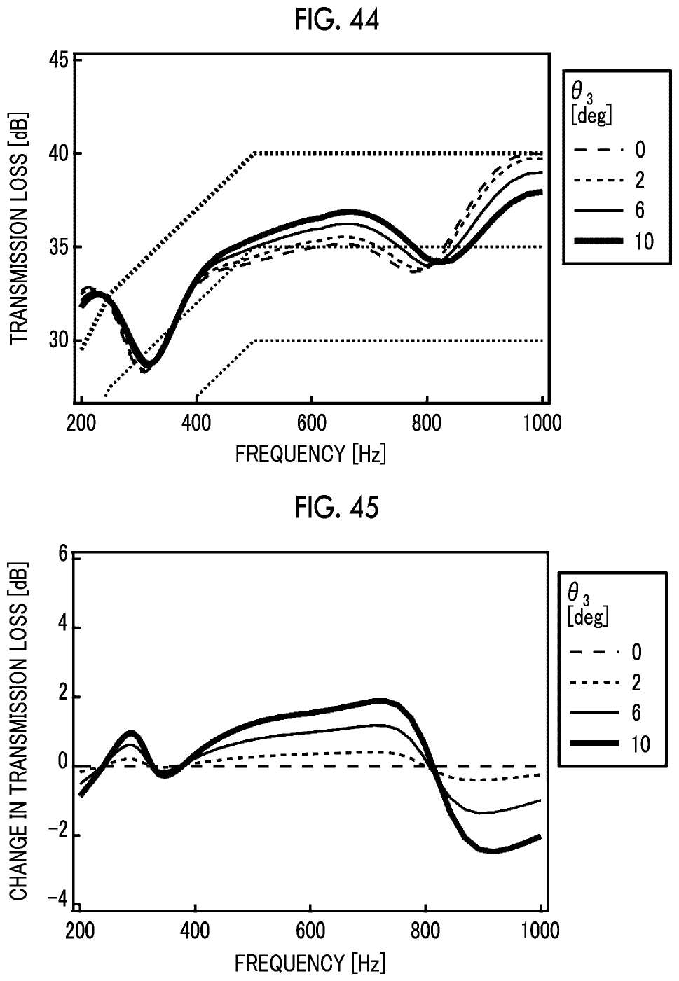

The results are shown in FIG. 44 as a graph showing the relationship between the frequency and the transmission loss. In addition, FIG. 45 shows a change amount of the transmission loss in a case in which the inclination angle θ₃ was 0°, as a graph. As shown in FIGS. 44 and 45, in a band between the frequencies of 400 Hz and 800 Hz, in a case in which the inclination angle θ₃ was 2° to 10°, the transmission loss was increased as compared with a case in which the inclination angle θ₃ was 0°. That is, it can be seen that the sound absorption property in the low frequency region was improved.

[Simulation 5]

In a simulation 5, a simulation was performed in the same manner as in the simulation 1 except that, as shown in FIG. 12, the transverse cross section of the silencing structure 22 has the shape in which the surface 31a was inclined at the inclination angle θ₃ and the surface 31b was inclined at the inclination angle θ₄, and as shown in FIG. 11, the front cross section of the silencing structure 22 had the rectangular shape in which the surface 31c and the surface 31d were not inclined, and the inclination angles θ₃ and θ₄ were changed to each of 0°, 2°, 6°, and 10°. A case in which the inclination angles θ₃ and θ₄ were 0° is Comparative Example, and cases in which the inclination angles θ₃ and θ₄ were 2°, 6°, and 10° are Examples.

It should be noted that the width of the cavity portion in the transverse cross section was 86 mm in a case in which the inclination angle θ₃ of the surface 31a and the inclination angle θ₄ of the surface 31b were 0°, and the width of the cavity portion in the front cross section was adjusted such that the volume of the cavity portion (opening portion) was constant in a case in which the inclination angles θ₃ and θ₄ were changed. The width of the cavity portion in the front cross section was 251 mm. In a case in which the inclination angles θ₃ and θ₄ were 2°, the cavity portion had the width W₁ on the opening portion side that was 90 mm and the cross-sectional area that was 22590 mm², and had the width W₂ on the closing portion side that was 77 mm and the cross-sectional area that was 19327 mm². In a case in which the inclination angles θ₃ and θ₄ were 6°, the cavity portion had the width W₁ on the opening portion side that was 100 mm and the cross-sectional area that was 25100 mm², and had the width W₂ on the closing portion side that was 59 mm and the cross-sectional area that was 14809 mm². In a case in which the inclination angles θ₃ and θ₄ were 10°, the cavity portion had the width W₁ on the opening portion side that was 110 mm and the cross-sectional area that was 27610 mm², and had the width W₂ on the closing portion side that was 42 mm and the cross-sectional area that was 10542 mm².

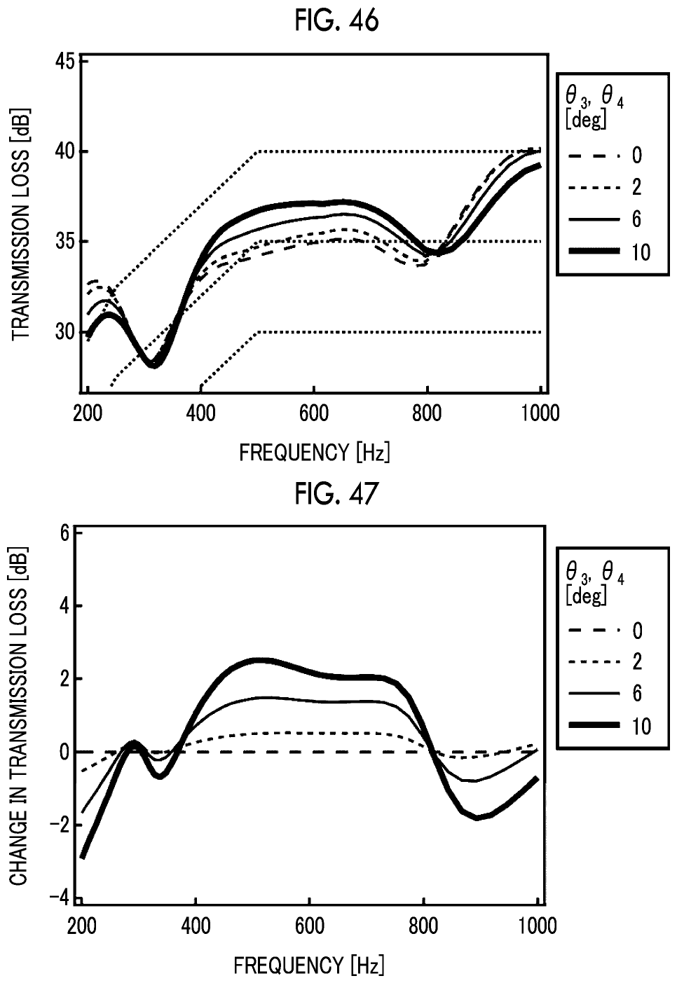

The results are shown in FIG. 46 as a graph showing the relationship between the frequency and the transmission loss. In addition, FIG. 47 shows a change amount of the transmission loss in a case in which the inclination angles θ₃ and θ₄ were 0°, as a graph. As shown in FIGS. 46 and 47, in a band between the frequencies of 400 Hz and 800 Hz, in a case in which the inclination angles θ₃ and θ₄ were 2° to 10°, the transmission loss was increased as compared with a case in which the inclination angles θ₃ and θ₄ were 0°. That is, it can be seen that the sound absorption property in the low frequency region was improved.

From the results described above, the effects of the present invention are clear.

### EXPLANATION OF REFERENCES

10, 10b: silencing system
12: tubular member
12a: connection hole
18: soundproof hood
20 air volume adjusting member
22, 22b: silencing structure
23a, 23b: component
24: porous sound absorbing material
25b: notch
26: opening
30 cavity portion
31a to 31d: surface
32: opening portion
36, 36b to 36g: rib structure
81: plate
122: silencer in related art
Ix: central axis of tubular member
W₁: width of cavity portion on opening portion side in transverse cross section
W₂: width of cavity portion on closing portion side in transverse cross section
W₃: width of cavity portion on opening portion side in front cross section
W₄: width of cavity portion on closing portion side in front cross section
θ₁ to θ₄: inclination angle of surface
Da, db: mold
D: dirt
H: rib height

What is claimed is:

1. A silencing structure that is installed in a tubular member, the silencing structure comprising:
a cavity portion;
an opening portion through which the cavity portion communicates with the tubular member; and
a closing portion that closes the cavity portion at a position facing the opening portion,
wherein a cross-sectional area of the cavity portion on a side of the opening portion is larger than a cross-sectional area of the cavity portion on a side of the closing portion, and
an outer shape of the silencing structure is a square frustum shape, and a porous sound absorbing material is provided in the cavity portion.

2. The silencing structure according to claim 1,
wherein at least one angle formed by line segments that are in contact with a vertex of the cavity portion that is not in contact with the opening portion is larger than π/2 [rad].

3. The silencing structure according to claim 1,
wherein, in a cross section perpendicular to an axial direction of the tubular member, a width of the cavity portion is narrowed as a distance from the opening portion is increased.

4. The silencing structure according to claim 1,
wherein the silencing structure has a rib structure.

5. The silencing structure according to claim 1,
wherein a density of members constituting the silencing structure is 0.5 g/cm³ to 2.5 g/cm³.

6. A silencing system in which the silencing structure according to claim 1 is installed in the tubular member, the silencing system comprising:
two or more silencing structures consisting of components having the same shape.

7. A silencing system in which the silencing structure according to claim 1 is installed in the tubular member, the silencing system comprising:
two or more silencing structures,
wherein at least two silencing structures are formed by one mold.

8. A silencing system in which the silencing structure according to claim 1 is installed in the tubular member,
wherein the silencing structure does not occupy 50% or more of a cross-sectional area perpendicular to an axial direction of the tubular member.

9. The silencing structure according to claim 2,
wherein, in a cross section perpendicular to an axial direction of the tubular member, a width of the cavity portion is narrowed as a distance from the opening portion is increased.

10. The silencing structure according to claim 2,
wherein the silencing structure has a rib structure.

11. The silencing structure according to claim 2,
wherein a density of members constituting the silencing structure is 0.5 g/cm³ to 2.5 g/cm³.

12. A silencing system in which the silencing structure according to claim 2 is installed in the tubular member, the silencing system comprising:
two or more silencing structures consisting of components having the same shape.

13. A silencing system in which the silencing structure according to claim 2 is installed in the tubular member, the silencing system comprising:
two or more silencing structures,
wherein at least two silencing structures are formed by one mold.

14. A silencing system in which the silencing structure according to claim 2 is installed in the tubular member,
wherein the silencing structure does not occupy 50% or more of a cross-sectional area perpendicular to an axial direction of the tubular member.

15. The silencing structure according to claim 3,
wherein the silencing structure has a rib structure.

16. The silencing structure according to claim 3,
wherein a density of members constituting the silencing structure is 0.5 g/cm³ to 2.5 g/cm³.

17. A silencing system in which the silencing structure according to claim 3 is installed in the tubular member, the silencing system comprising:
two or more silencing structures consisting of components having the same shape.

18. A silencing system in which the silencing structure according to claim 3 is installed in the tubular member, the silencing system comprising:
two or more silencing structures,
wherein at least two silencing structures are formed by one mold.

19. A silencing system in which the silencing structure according to claim 3 is installed in the tubular member,
wherein the silencing structure does not occupy 50% or more of a cross-sectional area perpendicular to an axial direction of the tubular member.

20. The silencing structure according to claim 4,
wherein a density of members constituting the silencing structure is 0.5 g/cm³ to 2.5 g/cm³.
